(19) United States
(12) Patent Application Publication
(10) Pub. No.: US 2026/0285238 A1
(43) Pub. Date: Sep. 24, 2026

(54) Modular Rack System for Bicycles and Snow Sports Equipment

(71) Applicant: Jeff A. Wilson, Lakewood, CO (US)

(72) Inventor: Jeff A. Wilson, Lakewood, CO (US)

(21) Appl. No.: 19/695,025

(22) Filed: Jun. 2, 2026

Related U.S. Application Data
(63) Continuation-in-part of application No. 18/491,986, filed on Oct. 23, 2023.
(60) Provisional application No. 63/386,510, filed on Dec. 8, 2022.
(60) Provisional application No. 63/480,569, filed on Jan. 19, 2023.
(60) Provisional application No. 63/489,433, filed on Mar. 10, 2023.

(51) Int. Cl. B60R 9/06; B60R 9/10; B60R 9/12

(52) U.S. Cl. CPC B60R 9/06; B60R 9/10; B60R 9/12

(57) ABSTRACT

A modular rack system for transporting bicycles and snow sports equipment within a truck bed is provided. The system includes a base positioned on the truck bed floor, having a lower frame portion configured to receive and secure bicycle wheels in an upright position. The lower frame portion includes both vertically and horizontally extending support members. An upper frame portion is detachably coupled to the lower frame portion and extends upwardly. Both the upper and lower vertical support members have a plurality of openings formed therethrough. A plurality of brackets are detachably mounted to the upper frame portion via a first set of openings to securely support snow sports equipment. At least one pin is adjustably mounted to a second set of openings, extending horizontally toward a side wall of the truck bed for lateral stability and reducing sway.

### PRIORITY CLAIM

This application is a continuation-in-part (CIP) of U.S. patent application Ser. No. 18/491,986 filed Oct. 23, 2023 for “Bicycle Rack” of Jeff A. Wilson, which claims the priority filing benefit of U.S. Provisional Patent Application No. 63/386,510 filed Dec. 8, 2022 for “Truck Bed Bicycle Rack” of Jeff A. Wilson, U.S. Provisional Patent Application No. 63/480,569 filed Jan. 19, 2023 for “Truck Bed Bicycle Rack” of Jeff A. Wilson, and U.S. Provisional Patent Application No. 63/489,433 filed Mar. 10, 2023 for “Bicycle Rack” of Jeff A. Wilson, each hereby incorporated by reference in its entirety as though fully set forth herein.

### BACKGROUND

Cycling and snow sports, such as skiing and snowboarding, continue to gain in popularity. Often, outdoor enthusiasts need to transport their bicycles to a bike path or trailhead, or their winter gear to the slopes, which is typically accomplished by driving their truck or car with the equipment on a rack attached to the vehicle. There are numerous single-purpose racks and rack attachments available to transport bicycles on vehicles, as well as separate, dedicated racks for transporting snow sports equipment. For example, such racks can be installed on the roof or trunk of a car. However, this often forces users to purchase multiple distinct rack systems and repeatedly swap them out depending on the season or the specific activity of the day.

Alternatively, pickup truck owners often bypass racks altogether and just toss their bicycles, skis, and snowboards loosely into the truck bed for transport. But this can result in damage (e.g., at least scratching) to the bicycle, the sharp edges and bindings of the snow sports equipment, and/or the truck bed itself. Hanging the front wheel of the bicycle over the tailgate of the pickup truck is also an option for many. But this too can cause damage to the bicycle and/or the truck bed, and leaves no organized space for accompanying snow sports equipment. Even when freestanding racks are placed in a truck bed, the dimensions of different truck beds vary, and lateral forces from driving can cause the rack and heavy equipment to sway or tip. Consequently, securely transporting different types of outdoor equipment, particularly without risking damage to the gear or the vehicle, remains a challenge.

### BRIEF DESCRIPTION OF THE DRAWINGS

FIGS. 1-3 show an example bicycle rack as it may be mounted on top of the side rail of a pickup truck bed to carry a bicycle on the side rail.

FIGS. 4-6 show another example bicycle rack as it may be mounted to the truck bed floor adjacent to the side of the bed of a pickup truck to carry a bicycle up out of the bed along the side rail.

FIGS. 7A and 7B show another example bicycle rack as it may be mounted to the truck bed floor along a side rail of a pickup truck bed to carry a bicycle at least partly down inside the truck bed along the side rail, both (A) without a bicycle, and (B) with a bicycle.

FIGS. 8A and 8B show an example bicycle rack as it may be mounted to a hitch receiver of a pickup truck bed to carry a bicycle behind the truck, both (A) without a bicycle, and (B) with a bicycle.

FIG. 9 shows the example bicycle rack of FIGS. 8A and 8B as it may be mounted to a hitch receiver of a pickup truck bed to carry a bicycle behind the truck.

FIGS. 10-11 show an example of one of the wedge tire stops on the base of the bicycle rack for securing a tire of the bicycle.

FIGS. 12-13 show an example of one of the wedge tire stops on the wheel stabilizers for securing a tire of the bicycle.

FIG. 14 shows the example of one of the wedge tire stops of FIG. 13 with a bicycle tire.

FIG. 15 is a perspective view of a modular rack system configured for a bicycle as it is installed inside the bed of a pickup truck.

FIG. 16 is a perspective view of the modular rack system configured for a bicycle and snow sports equipment as it may be mounted in a pickup truck bed.

FIG. 17 is a perspective view of the modular rack system shown as it may be loaded with outdoor recreational equipment inside the truck bed, including an upright bicycle, a snowboard, and multiple pairs of skis.

FIG. 18 shows a reverse profile view of the fully loaded modular rack system of FIG. 17, showing how the bicycle, snowboard, and skis may appear when standing outside of the truck next to the truck bed side.

FIG. 19 is a perspective view of the modular rack system separated from the vehicle.

FIG. 20 is a side elevation view of the modular rack system corresponding to FIG. 19.

FIG. 21 is a front elevation view of the modular rack system corresponding to FIG. 19.

### DETAILED DESCRIPTION

Examples of bicycle racks are disclosed for mounting to a truck bed (on and along the side rail, as well as at least partly inside the truck bed), and for mounting to a hitch receiver of a truck or other vehicle. The example bicycle racks can be made of welded steel, although other materials (e.g., aluminum, carbon fiber) and other types of connections (e.g., screws/bolts) may be provided. In an example, the bicycle rack may include adjustable components (e.g., sliding tire trays, down-leg mounts, and adjustable wedges for securing the tires of the bicycle) to accommodate different size bicycles.

In an example, the bicycle rack is mounted to a side rail of the truck bed, and a bicycle is mounted to the bicycle rack, thus mounting the bicycle to the truck bed. In this example, the frame of the bicycle rack includes a base that is securely anchored to the side rail of the truck bed, a frame stabilizer connected to the base, and a wheel mounting assembly for the bicycle wheels. During use, the bicycle wheels are positioned in the wheel mounting assembly, and the bicycle frame is connected to the frame stabilizer. The bicycle is thus mounted on the truck bed rail and sits substantially above the top of the truck bed rail. The frame stabilizer reduces or altogether eliminates sway of the bicycle during transport. The frame stabilizer absorbs most, if not all of the sway or travel energy. The truck bed is completely unobstructed for hauling and line of sight, both of the driver and other vehicles on the road.

In another example, the bicycle rack includes a frame stabilizer with an artistic element. Also in this example, the bicycle rack is mounted to the floor of the truck bed. It is noted that combinations of these are also contemplated. For example, the bicycle rack that is mounted to the side rail of the truck may have an artistic element and/or the bicycle rack that does not have an artistic element may include down-legs to mount the bicycle rack to the floor of the truck bed.

In another example, the bicycle rack is mounted to the floor of the truck bed, but with the base at or about level with the wheel well of the truck. In this example, the bicycle sits at least partly down inside the truck bed.

In another example, the bicycle rack is mounted to a hitch receiver, and the bicycle is mounted to the bicycle rack, thus mounting the bicycle rack to the back of the truck (outside of the truck bed). In this example, the frame of the example bicycle rack includes a base that is securely anchored to the truck hitch, and a wheel mounting assembly for the bicycle wheels. During use, the bicycle wheels are positioned in the wheel mounting assembly. Optional wheel stabilizers may be rotated over the front and/or rear wheels of the bicycle. Tire wedges in the base and/or on the wheel stabilizers help to reduce or altogether eliminate sway and fore/aft movement of the bicycle during transport.

A modular rack system is also disclosed for securely transporting a combination of one or more bicycles and snow sports equipment in a truck bed. The system includes a base configured to be positioned on a floor of a truck bed for receiving wheels of a bicycle to secure the bicycle in an upright position. A lower frame portion of the base includes at least two vertically extending lower support members and at least one horizontally extending lower support member located between the at least two vertically extending lower support members. An upper frame portion connects to the lower frame portion of the base. The upper frame portion has at least two vertically extending upper support members and at least one horizontally extending upper support member positioned between the at least two vertically extending upper support members. This upper frame portion is configured to receive and support snow sports equipment elevated above the base. Furthermore, the system includes at least one adjustable pin extending horizontally from the lower frame portion and/or the upper frame portion, configured to extend toward a wall of the truck bed for reducing sway.

In another example, a modular rack system for a truck bed includes a base configured to be positioned on a floor of a truck bed, and a lower frame portion of the base that includes at least two vertically extending lower support members. An upper frame portion extends upward from the lower frame portion and includes at least two vertically extending upper support members. A plurality of openings are formed along the vertically extending upper and lower support members. The system can be provided with a plurality of brackets detachably mounted to the upper frame portion via a first set of the plurality of openings, extending outwardly from the upper frame portion and configured to support snow sports and/or other equipment. Additionally, at least one stabilizer pin is adjustably mounted to a second set of the plurality of openings on either the upper frame portion or the lower frame portion, extending horizontally and configured to contact a side wall of the truck bed to provide lateral stability.

In yet another aspect, a modular rack system for securely transporting a combination of one or more bicycles and snow sports equipment (and/or other equipment) in a truck bed includes a base configured to be positioned on a truck bed floor. A lower frame portion of the base has at least two vertically extending lower support members, at least two additional vertically extending lower support members set apart from and substantially parallel to the at least two vertically extending lower support members, and at least one horizontal support member. An upper frame portion extends upward from the lower frame portion and has at least two vertically extending upper support members. The upper frame portion is detachably coupled to the lower frame portion such that the upper frame portion can be separated and removed from the lower frame portion. The vertically extending upper support members and the vertically extending lower support members each include a plurality of openings formed therethrough. A plurality of substantially brackets are detachably mounted to the upper frame portion via a first set of the plurality of openings. At least one stabilizing pin is adjustably mounted to a second set of the plurality of openings on either the vertically extending upper support members and/or the vertically extending lower support members. The at least one pin extends horizontally from the upper or lower frame portion and is configured to extend toward a wall of the truck bed to reduce sway.

In an example, the upper frame portion may be detachably coupled to the lower frame portion by a suitable coupling, such as but not limited to, a telescopic coupling or a ferrule connection such that the upper frame portion can be separated and removed from the base. To accommodate the varying dimensions of different truck beds, at least one stabilizing pin may be selectively positioned to extend a desired distance from the rack system to the side wall of the truck bed. This pin may also be movable between the plurality of openings to allow for placement of the rack system at different distances from the side wall while the pin still makes contact with the side wall of the truck bed to provide stabilization. In an example, the base can be configured to securely anchor directly to the floor of the truck bed and/or be held securely in place by at least one strap.

To hold snow sports equipment, the modular rack system may further include one or more brackets that extend outwardly from the upper support members. These brackets may be any suitable configuration, and in an example are substantially U-shaped or hook-shaped.

To support the front and rear tires of a bicycle, the lower frame portion of the base may include additional vertically and horizontally extending lower support members set apart from and substantially parallel to the primary lower support members of the base, and supporting the tires therebetween.

Additionally, at least one cross brace may be positioned between the horizontally extending lower support members for reinforcement of the base. Furthermore, both the upper and lower frame portions may have the plurality of openings formed therethrough as mounting points for both the brackets and the at least one anti-sway pin.

These example bicycle racks are each designed to safely transport bicycles in a truck or other vehicle equipped with a suitable mounting location for the bicycle rack over the wheel well of the truck bed.

Before continuing, it is noted that as used herein, the terms “includes” and “including” mean, but is not limited to, “includes” or “including” and “includes at least” or “including at least.” The term “based on” means “based on” and “based at least in part on.”

It is also noted that the examples described herein are provided for purposes of illustration, and are not intended to be limiting. Other devices and/or device configurations may be utilized to carry out the operations described herein.

The operations shown and described herein are provided to illustrate example implementations. It is noted that the operations are not limited to the ordering shown. Still other operations may also be implemented.

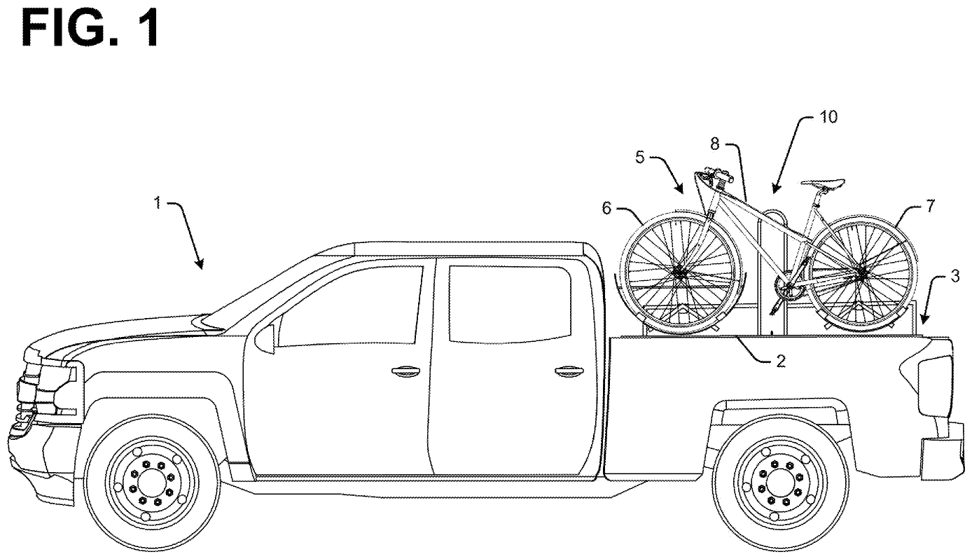

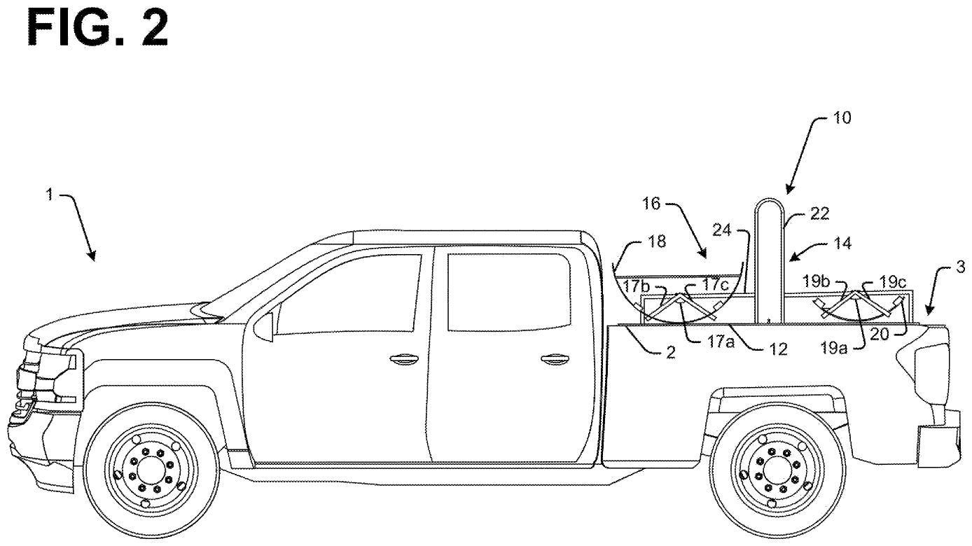

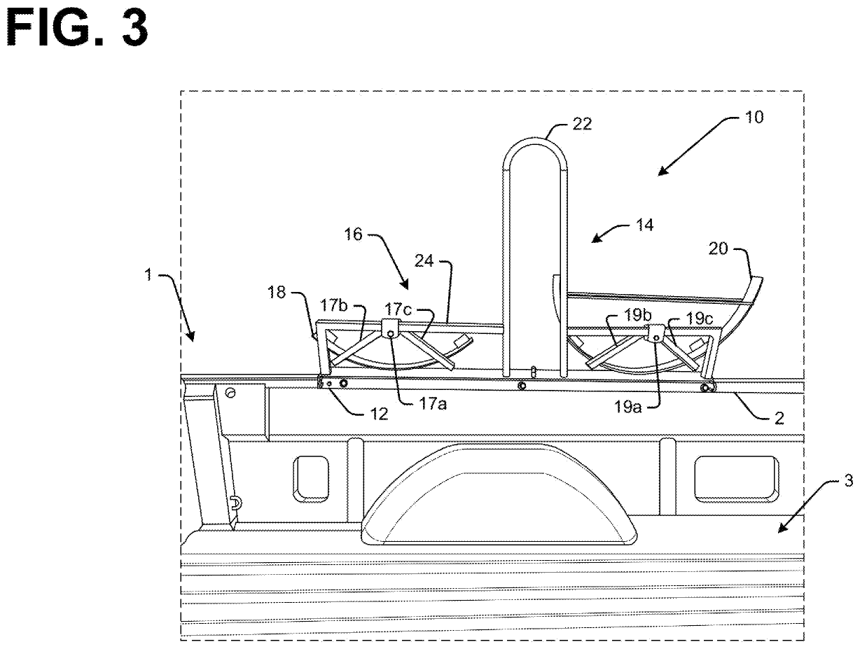

FIGS. 1-3 show an example bicycle rack 10 as it may be mounted to the side rail 2 of a bed 3 of a pickup truck 1 to carry a bicycle 5 on the side rail 2. An example of the bicycle rack 10 includes a base member (or base) 12 that can be securely anchored to a side rail 2 of a truck bed 3, a frame stabilizer 14 connected to the base 12, and a wheel mounting assembly 16 having a front wheel mount 18 and a rear wheel mount 20 for receiving the two wheels 6 and 7 of the bicycle 5.

In an example, the base 12 has a substantially L-shaped side profile with a top plate for positioning on top of the side rail 2, and a lip for positioning along the inside of the truck bed 3 on the side rail 2. The shape thus reduces or altogether eliminates side-to-side movement of the bicycle rack 10. The base 12 can be bolted or otherwise secured to the side rail 2 of the bed 3 of the truck 1. The bicycle rack 10 can be mounted to either side of the truck bed. In an example, separate racks (not shown) can be mounted to both side rails 2 of the bed 3 of the truck 1. In another example, the bicycle rack 10 can be expanded (e.g., made wider) to accommodate multiple bicycles and/or other equipment and/or accessories.

The frame stabilizer (or stabilizer) 14 of the bicycle rack 10 includes a vertically extending, generally U-shaped support member 22. The stabilizer also includes a horizontally extending support member 24. The wheel mounting assembly 16 may be at least partly mounted to the stabilizer 14 (e.g., the vertical support member 22 and/or horizontal support member 24), and/or to the base 12. As such, the stabilizer 14 reduces or altogether eliminates sway of the bicycle 5 during transport.

In an example, the wheel mounting assembly 16 has both a front wheel tray 18 and a rear wheel tray 20. In an example, the wheel trays may be semi-circular to correspond to the shape of the bicycle wheels 6 and 7. Other shapes are also contemplated as being within the scope of this disclosure. Also in an example, the front wheel tray 18 may be larger (e.g., taller) than the rear wheel tray 20. Such a configuration helps hold the front wheel 6 of the bicycle 5 in an upright fixed position while the user is mounting the bicycle 5 onto the bicycle rack 10. That is, the user may first position the front wheel 6 of the bicycle 5 in the wheel mounting assembly 16, and then, with the front wheel held in place by the front wheel tray 18, swing the bicycle 5 over the bicycle rack 10. Again, other sizes of the wheel trays 18 and 20 are also contemplated as being within the scope of this disclosure.

In an example, one or both of the front wheel tray 18 and the rear wheel 20 tray may be slidably mounted to the base 12 (e.g., at connection 17a) and/or to the horizontal support member 24 (e.g., via cross braces 17b and 17c). This enables the user to adjust the distance between the front wheel tray 18 to accommodate different bicycle sizes. In another example, the rear wheel tray 20 is also slidably mounted to the base 12 (e.g., at connection 19a) and/or to the horizontal support member 24 (e.g., via cross braces 19b and 19c). In another example, the rear wheel tray 20 is fixedly mounted (so that it is not adjustable) to the base 12). In an example, one of the wheel trays is shorter in length than the other wheel tray to help reduce or altogether eliminate fore and aft movement, and to accommodate different sizes of bicycles.

During use, the user can position the two wheels 6 and 7 of the bicycle 5 in the wheel mounting assembly 16 so that the bicycle 5 stands upright on the bicycle rack 10. In an example, the user may first position the front wheel 6 of the bicycle 5 in the wheel mounting assembly 16, and then swing the bicycle 5 over the bicycle rack 10 so that the rear wheel 7 is positioned in the wheel mounting assembly 16. The user can use both hands to secure the bicycle 5 to the bicycle rack 10 for transport. The frame 8 of the bicycle 5 can then be connected to the stabilizer 14 of the bicycle rack 10 (e.g., with straps) to securely mount the bicycle 5 along the side rail 2 of the bed 3 of the truck 1. Once secured, the bicycle 5 sits substantially above the side rail 2 of the bed 3 of the truck, out of the way of the driver's view out the back window of the truck 1, and without taking up cargo space within the bed 3 of the truck 1.

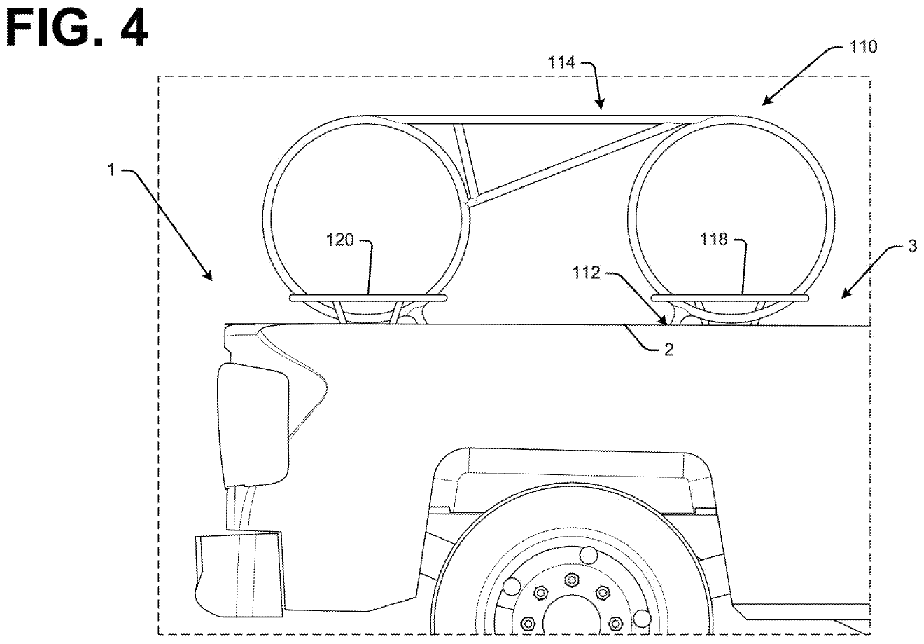

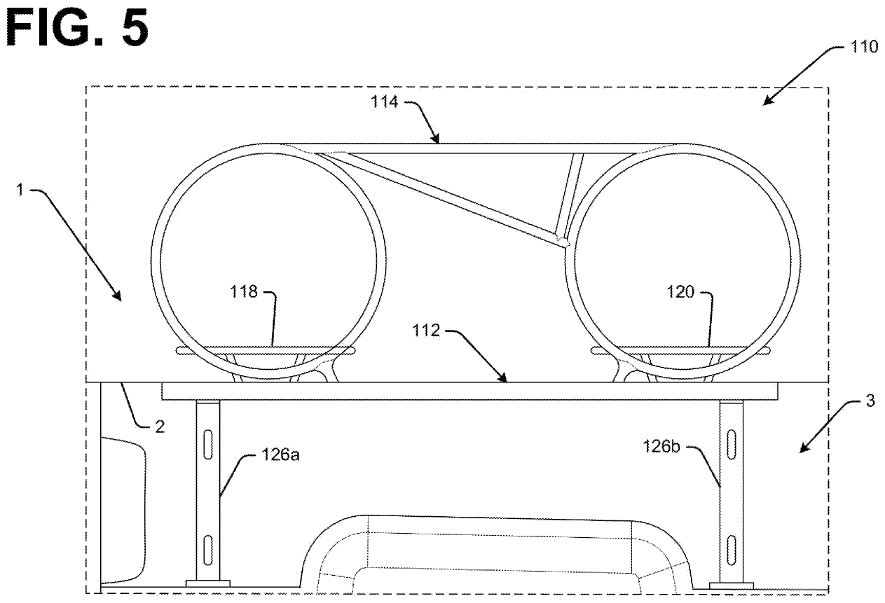

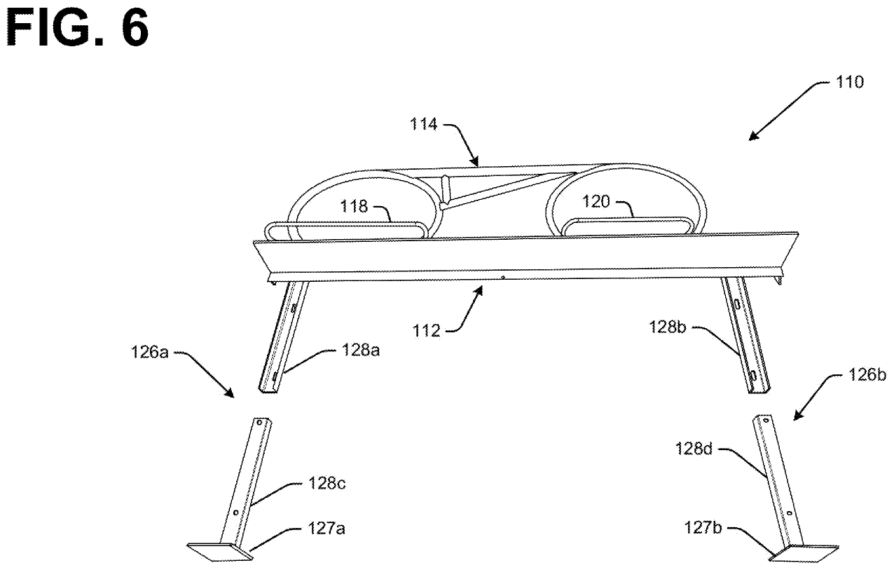

FIGS. 4-6 show another example bicycle rack 110 having a stabilizer 114 with an artistic design element. It is noted that 100-series reference numbers are used in FIGS. 4-6 to correspond to like components already described above with reference to FIGS. 1-3.

The bicycle 5 is carried in substantially the same position as that shown in FIG. 1 for bicycle rack 110, alongside the side rail 2 and up out of the bed 3 of the truck. In the example shown, the bicycle rack 110 is sized to accommodate a single bicycle. In another example, the bicycle rack 110 can be expanded (e.g., with wheel trays 118 and 120 on each side of the stabilizer 114) to accommodate multiple bicycles and/or other equipment.

The stabilizer 114 of the example bicycle rack 110 has an artistic design element, referred to herein as the “Art” or “Art Frame”. In an example, the stabilizer 114 is a silhouette of a bicycle (hence the “Art”). The “Art” is a form of communication. People who favor a sport want to express themselves to connect with like-minded people (e.g., other bicyclists). In addition, the “Art” adds some ‘swagger’ to the pickup truck. Other forms of the “Art” may include silhouettes of mountains, trees, bears (or other animals) and/or other art forms.

In an example, the bicycle rack is made of tubular components, to further enhance the artistic element. All of the components, including the stabilizer 114 and wheel trays 118 and 120, may be formed with matching tubular steel (or other suitable materials).

The stabilizer 114 is configured with wheel openings having sufficient space for the bicycle axles. Additional space is provided between the wheel silhouettes to provide space for the sprocket and pedals of the bicycle 5.

The tire trays of the example truck bed bicycle rack shown in these figures may be smaller, so as to not interrupt the lines of the “Art.” The front tire tray 118 is smaller than the rear tire tray 120. This helps to reduce or altogether eliminate fore and aft movement of the bicycle by better fitting the front wheel. The rear tire tray 120 is longer to accommodate different sizes of bicycles.

It is noted that older trucks have side rails made with double wall construction. This older design better supports the bicycle rack 10 mounted to the side wall 2 of the bed 3 of the truck 1. Many newer trucks are now made with single wall side rails that may not support the bicycle rack 10 mounted to the side wall 2 of the bed 3 of the truck 1. Accordingly, the base 112 of the bicycle rack 100 is shown as it may be mounted to the floor of the truck 3. In an example, the bicycle rack 110 includes at least one down-leg 126a-b on the base 112. the down-leg(s) 126a-b may be positioned inside and mounted (e.g., via bolting platform 127a-b) to the floor of the truck bed 3. The base 120 of the bicycle rack 110 may also be mounted to the side rail 2, e.g., for additional stability. It is noted that either bicycle rack (10 and 110) may include down-legs 126a-b to provide additional support for mounting to the bed 3 of the truck 1.

In an example, the down-leg(s) 126a-b may be adjustable in height, e.g., to accommodate different depth truck beds. In an example, the down-leg(s) 126a-b may include separate members 128a-d with multiple openings and/or slotted channels to accept a nut and bolt that can be tightened at various positions to adjust the height of the down-legs 126a-b.

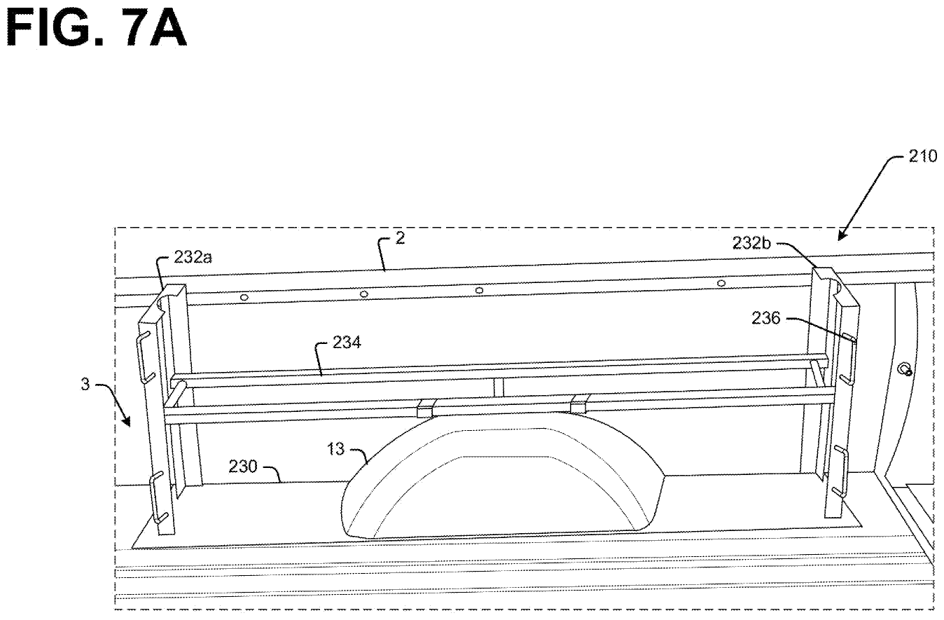

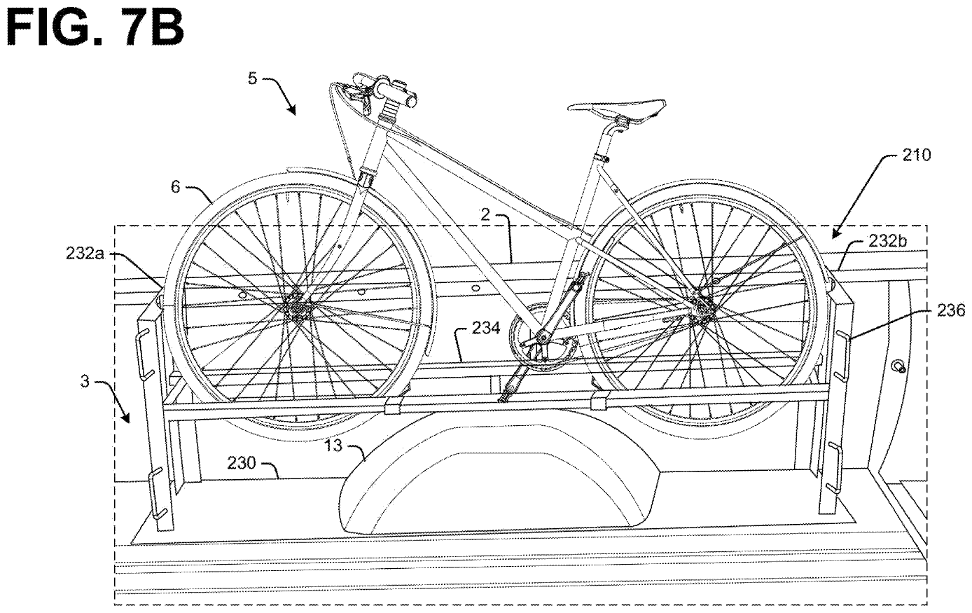

FIGS. 7A and 7B show another example bicycle rack 210 as it may be mounted to the truck bed floor along a side rail of a pickup truck bed to carry a bicycle at least partly down inside the truck bed along the side rail, both (A) without a bicycle, and (B) with a bicycle 5. It is noted that 200-series reference numbers are used in FIGS. 7A and 7B to correspond to like components already described above with reference to FIGS. 1-3 and FIGS. 4-6.

The bicycle rack 210 may be mounted to the floor of the truck bed 3 along a side rail 2 of a truck to carry a bicycle 5 at least partially inside of the truck bed 3. In the example shown, the bicycle rack 210 is sized to accommodate a single bicycle. In another example, the bicycle rack 210 can be expanded to accommodate multiple bicycles and/or other equipment.

The example bicycle rack 210 is provided on a floor plate 230 that rest on (e.g., to avoid drilling into the floor of the truck bed 3) or may be bolted to the floor of the truck bed 3.

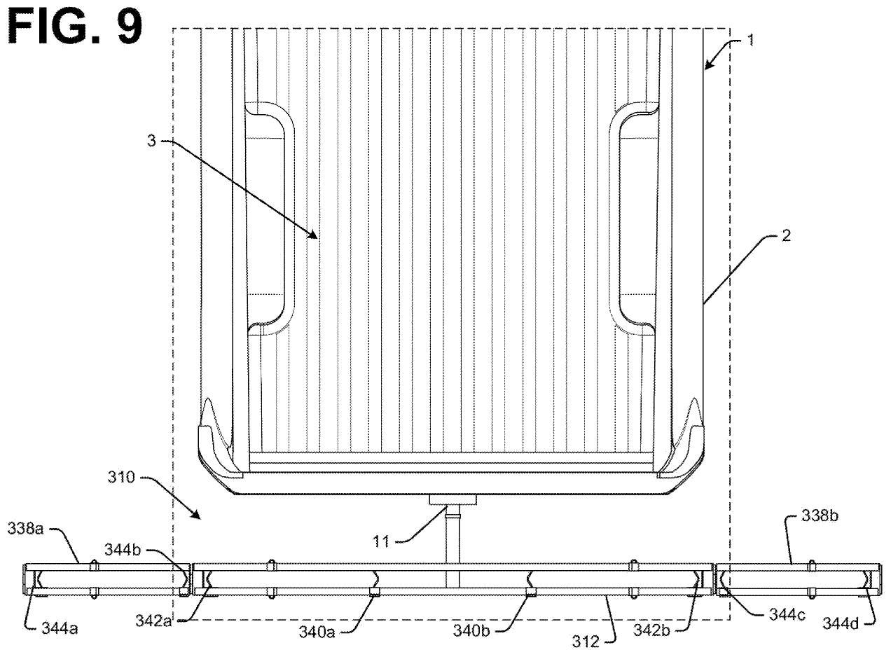

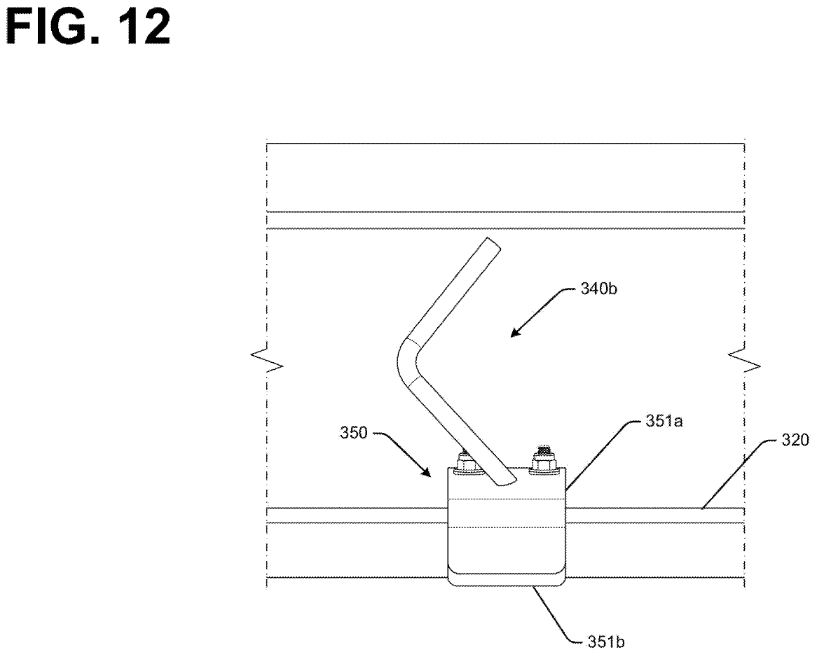

The bicycle rack 210 includes a frame assembly having vertical members 232a-b and cross member 234 having wheel slots or channels formed therein. In an example, the cross member 234 is positioned just above the wheel well 13, and the wheels 6 and 7 of the bicycle 5 fit into the slots in cross member 234. More than one wheel channel or slot may be formed in the cross member to accommodate additional bicycles. The vertical members 232a-b may be a fixed height, or made adjustable to accommodate different depths of truck beds and/or wheel well sizes. The bicycle 5 may be strapped (e.g., to handles 236 or other connection points and/or to the truck bed 3). Optional wheel channel dividers (not shown in FIGS. 7A and 7B) may be provided to secure the wheels 6 and 7 of the bicycle 5 (see, e.g., FIGS. 9 and 12).

It can be seen in FIG. 7B how the wheels 6 of the bicycle 7 drop below and/or into the two-rail platform, thereby lessening overhead sway of the bicycle 7 which could otherwise potentially damage the bicycle 5 and/or the bed 3 of the truck 1.

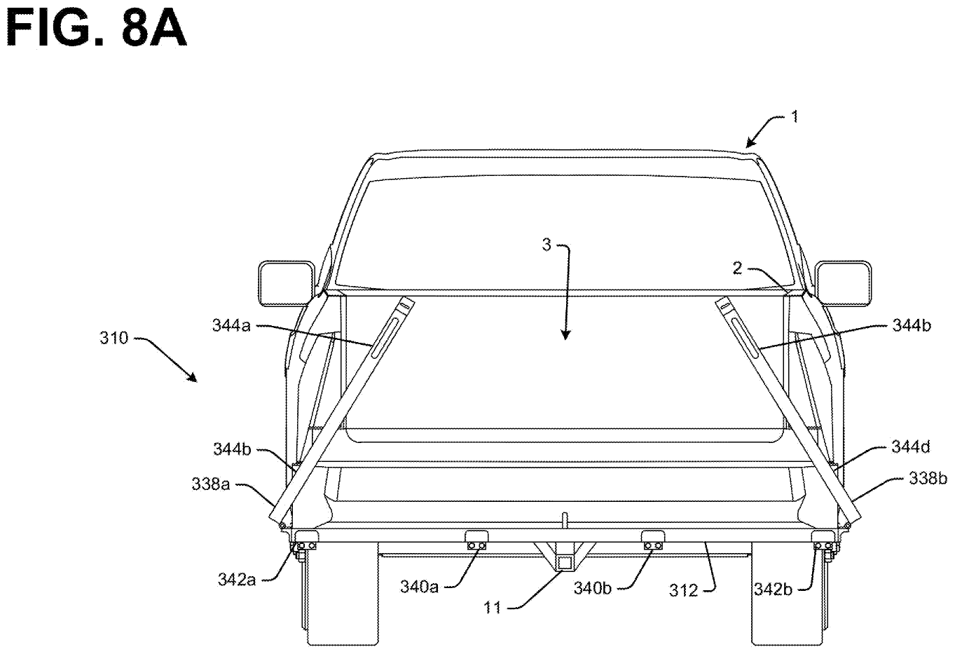

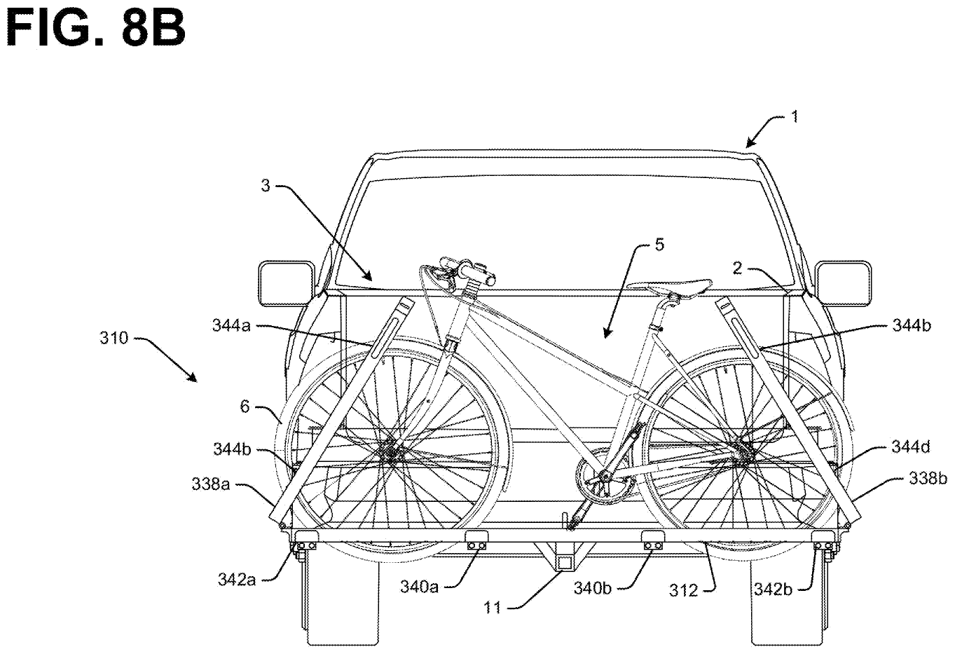

FIGS. 8A and 8B show an example bicycle rack 310 as it may be mounted to a hitch receiver 11 of a pickup truck to carry a bicycle 5 behind the truck 1, both (A) without a bicycle, and (B) with a bicycle 5. FIG. 9 shows the example bicycle rack 310 of FIGS. 8A and 8B as it may be mounted to a hitch receiver 11 of a pickup truck 1 to carry a bicycle 5 behind the bed 3 of the truck 1. It is noted that 300-series reference numbers are used in FIGS. 8-9 to correspond to like components already described above with reference to FIGS. 1-3, FIGS. 4-6, and FIGS. 7A and 7B.

The bicycle rack 310 may be mounted to a hitch receiver 11 of a truck 1 or other vehicle to carry a bicycle 5 behind the bed 3 of the truck 1 or other vehicle. The example bicycle rack 310 can be bolted or otherwise secured (e.g., via pin) to the receiver hitch of a truck or other vehicle equipped with a suitable mounting system.

The bicycle 5 may be secured to the bicycle rack 310 with optional straps and/or other connections to reduce or altogether eliminate sway. In the example shown, the hitch-mounted bicycle rack 310 accommodates a single bicycle. The installed bicycle 5 sits on the base 312 with the wheels 6 and 7 partly down into the channel formed in the base 312 (similar to the examples shown in FIGS. 7A and 7B). The bicycle rack 310 may carry a single bicycle, or be widened to accommodate multiple bicycles and/or other equipment.

This example of the bicycle rack 310 includes a base 312 for securely attaching to a hitch receiver of a truck or other vehicle. The base 312 is formed with a wheel mounting assembly 316 including at least one channel for receiving the wheels 6 and 7 of the bicycle 1. At least one wheel stabilizer 338a-b is connected to the base 312. The wheel stabilizers 338a-b reduce or altogether eliminate sway of the bicycle 1 during transport.

In an example, the wheel mounting assembly 316 has a front wheel slot 318 and a rear wheel slot 320. The wheel slots 318, 320 may be formed within a single channel, or formed as separate channels in the base 312. In an example, wedges 340a, 340b may form the front wheel slot 316 and the rear wheel slot 318. The wedges 340a, 340b may be mounted on the base 312 to slide to different positions within the base 312 to accommodate different size tires (and thus different bicycle sizes).

In an example, the front wheel slot 318 may be made shorter than the rear wheel slot 320 to help reduce or altogether eliminate fore and aft movement of the bicycle. The rear tire slot 320 may be longer to accommodate different sizes of bicycles and/or tire size. In another example, one or both of the tire slots 318, 320 may be adjustable to accommodate different size bicycle tires, e.g., to include larger e-bicycles and motorized dirt bikes.

An example of the bicycle rack includes a base having at least one slot for receiving the two wheels of the bicycle. A size adjustable wheel mounting assembly 316 of the base 320 has a first front wedge tire stop 342a and a first rear wedge tire stop 340a for receiving the front wheel 6 of the bicycle 1. The wheel mounting assembly 316 also has a second front wedge tire stop 340b and a second rear wedge tire stop 342b for receiving the rear wheel 7 of the bicycle 1. The wedge tire stops serve to better secure the wheels of the bicycle 1 against horizontal movement.

In an example, the wheel stabilizer 338a includes a front wheel arm 338a rotatable between an open position (shown in FIG. 9) for mounting the bicycle 1 on the bicycle rack 310. The front wheel arm 338a is also rotatable to a closed position (shown in FIGS. 8A and 8B) for securing the front wheel 6 of the bicycle 1. In an example, there is both a front wheel arm 338a and a rear wheel arm 338b. The rear wheel arm 338b is rotatable between an open position (shown in FIG. 9) for mounting the rear tire 7 of the bicycle 1. The rear wheel arm 338b is also rotatable to a closed position (shown in FIGS. 8A and 8B) for securing the rear wheel 7 of the bicycle 1. The front wheel arm 338a and the rear wheel arm 338b have slots that fit at least partially around the front wheel 6 and the rear wheel 7 of the bicycle 1 to hold the bicycle 1 in an upright position.

In an example, the front wheel arm 338a and the rear wheel arm 338b each have wedge tire stops (e.g., upper and lower tire stops) at positions 344a-d shown in FIGS. 8 and 9. The wedge tire stops serve to better secure the wheels of the bicycle 1 against vertical movement.

In an example, there are four wedge tire stops (or tire hugger brackets) on each tire (four on the front tire 6, and four on the rear tire 7) to absorb the energy generated by the vehicle travel.

It can be seen in FIG. 8B how the wheels 6 of the bicycle 5 drop below and/or into the two-rail platform, thereby lessening overhead sway of the bicycle 7 which could otherwise potentially damage the bicycle 5 and/or the bed 3 of the truck 1.

The bicycle 1 is secured both the front and rear tires 6 and 7 to eliminate any physical damage or paint damage to the bicycle and/or vehicle. In an example, all of the wedge tire stops may be moveable. In another example, one or more of the opposing wedge tire stops may be fixedly mounted to the base, and only the other of the opposing wedge tire stops is adjustable.

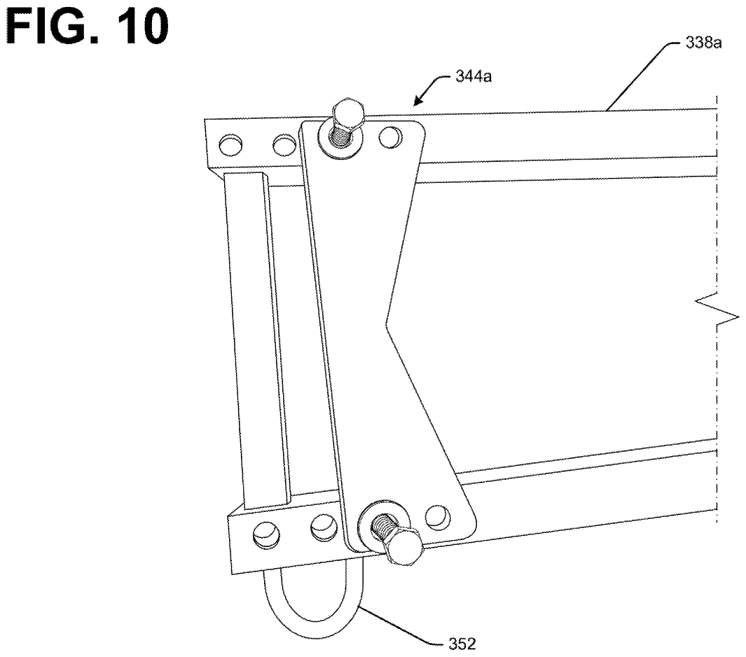

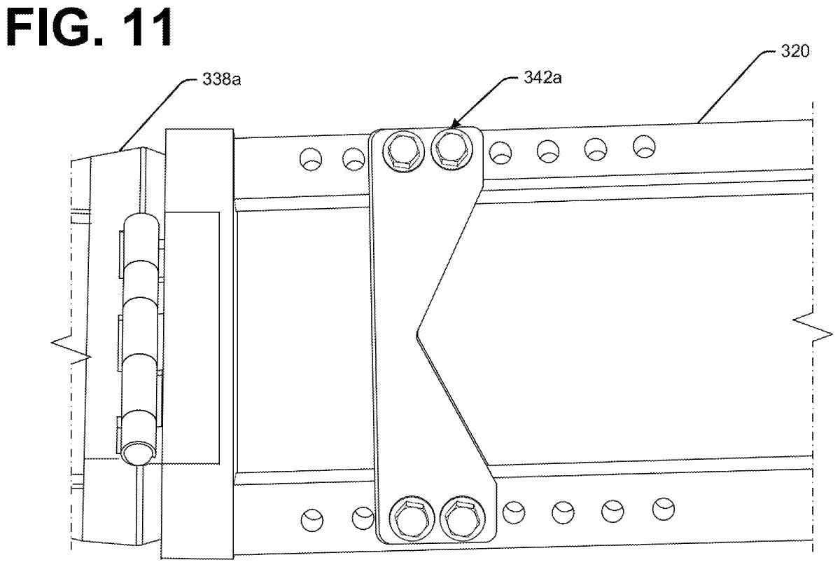

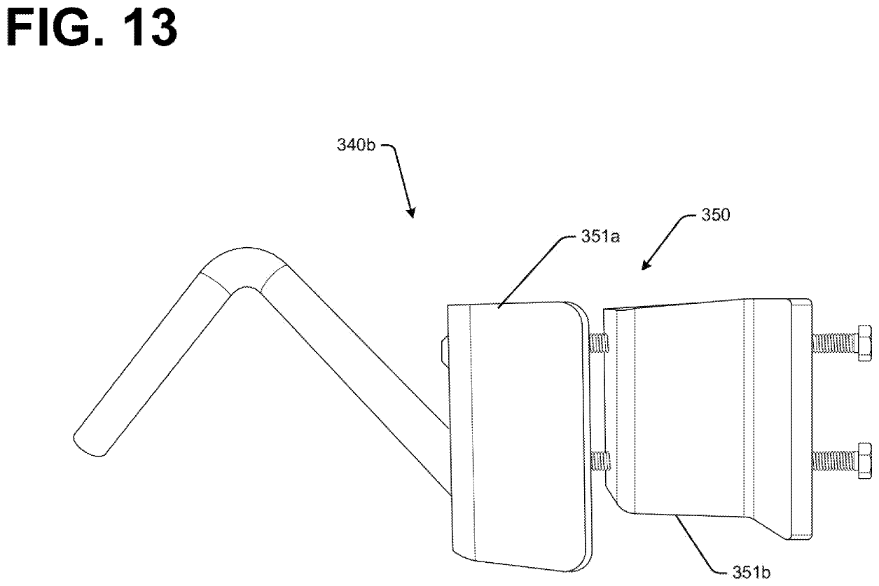

Examples of the wedge tire stops are shown in FIGS. 10-11 and 12-13. Although the example shown in FIGS. 10-11 includes wedge tire stops 342a and 342b, and the example shown in FIGS. 12-13 includes wedge tire stops 340a and 340b, it is noted that any of these wedge tire stops may be provided in any position in the base 320. Likewise, any wedge tire stops (e.g., 340a-b and 342a-b and/or others) may be provided on the front wheel arm 338a and the rear wheel arm 338b. In addition, other examples of the wedge tire stops (not shown) may also be provided, as will be readily understood by those having ordinary skill in the art after becoming familiar with the teachings herein.

The front wheel slot and the rear wheel slot may have opposing wedge tire stops. FIGS. 10-11 show an example of wedge tire stops (e.g., 340a, 342a, and 344a-d in FIG. 9) which may be provided on the bicycle rack 310 for receiving a tire of the bicycle 1 therebetween. In this example, the wedge tire stops may be secured on both sides. The wedge tire stops may be generally V-shaped to better fit at least partly around the bicycle tires. In addition, various connection points (e.g., loop 352) may be provided at various places on any of the example bicycle racks for attaching straps to help secure the bicycle 5.

The wedge tire stops 340a, 342a, and 344a-d receive the tire of the bicycle therebetween to limit sway of the bicycle 1 all three planes in the x-y-z coordinate system. The wedges can be tightened in place, and/or loosened for adjustment (e.g., to accommodate larger or smaller tires, and/or so that the bicycle can sit down lower or up higher in the rack).

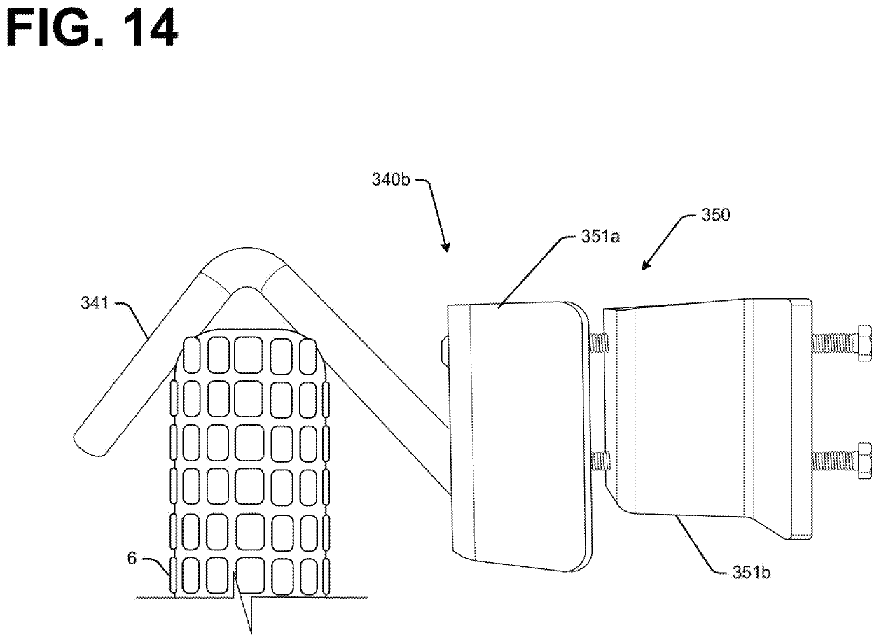

FIGS. 12-13 show an example of wedge tire stops (e.g., 340b and 342b in FIG. 9) which may be provided on the bicycle rack 310 for receiving a tire of the bicycle 1 therebetween. FIG. 14 shows the example of one of the wedge tire stops of FIG. 13 with a bicycle tire 6. In this example, the wedge tire stops may be secured on only one side. The wedge tire stop may be mounted via bracket assembly 350 having mating L-shaped brackets 351a, 351b that clamp that is bolted together around the square tube portion of base 320 and/or members 338a, 338b. Loosening the bolts enables the brackets to slide along the tubing for adjustment. It is noted that the tubing of base 320 and/or members 338a, 338b need not be square, and thus the brackets 351, 351b may be sized and shaped to work with any size and/or shape tubing.

The wedge tire stops are hook-shaped (or generally V-shaped) to better fit at least partly around the bicycle tires. The wedge tire stops 340a, 342a, and 344a-d receive the tire of the bicycle therebetween to limit sway of the bicycle 1 all three planes in the x-y-z coordinate system. The wedges can be tightened in place, and/or loosened for adjustment (e.g., to accommodate larger or smaller tires, and/or so that the bicycle can sit down lower or up higher in the rack).

The tire wedges into the bracket, thereby hugging 3 sides of the bicycle tire 6. The deep V bracket is shown as it may secure 1″ wide to 4″ wide tires and/or secure a race bicycle 5 to a fat tire bicycle. Four brackets on each tire hold the bicycle 5 upright without touching any painted surface.

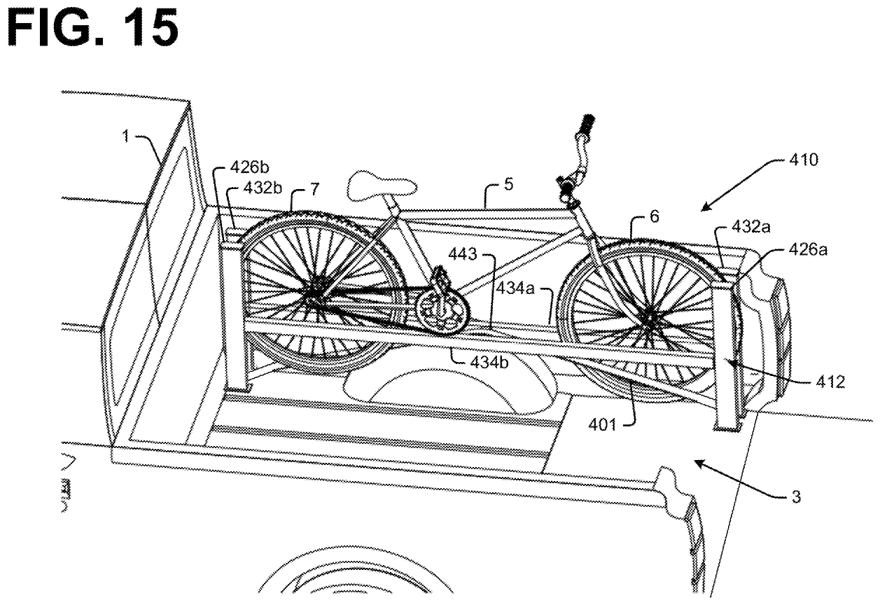

FIGS. 15-21 show an example of a modular rack system 410 as it may be configured to carry bicycles 5 and/or snow sports equipment (e.g., snowboard 406 and skis 407). In these figures, 400-series reference numbers are used in FIGS. 15-21 to correspond to like components already described above (as applicable). It is noted that the configuration shown in these figures is for a single bicycle 5. However, multiple bases 412 and/or components of the base 412 and/or the structure of the base 412 itself could be configured to hold more than one bicycle in an upright position in a substantially parallel format to the bicycle 5 shown in these drawings.

FIG. 15 is a perspective view of a modular rack system 410 configured for a bicycle 5 as it is installed inside the bed 3 of a pickup truck 1. As shown, the modular rack system 410 includes a base 412 configured to be positioned on a floor of a truck bed 3 for receiving the wheels 6, 7 of at least one bicycle 5 to secure the bicycle 5 in a substantially upright position. The horizontal components of the system 410 span along the length of the truck bed 3 parallel to a side wall of the truck bed 3. In an another configuration, the base 412 and/or lower frame portion 414 can be expanded or duplicated laterally to hold more than one bicycle 5 in a parallel format within the truck bed 3. Additionally, the base 412 may be configured to rest freely on the floor of the truck bed 3 and be held securely in place by at least one strap 401, or alternatively, it may be configured to securely anchor directly to the floor via bolts or similar fasteners to suit different user preferences and hauling requirements.

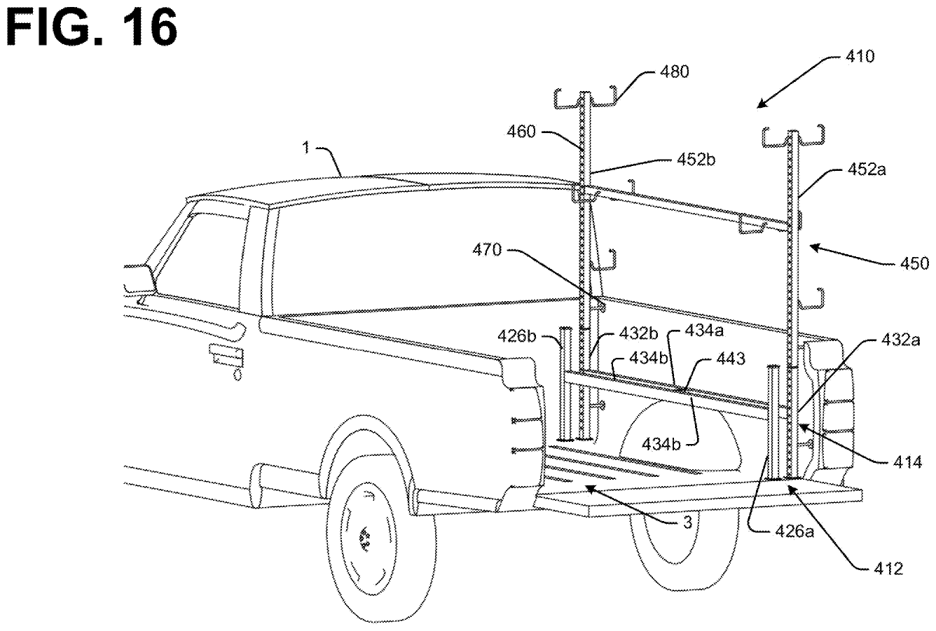

FIG. 16 is a perspective view of the modular rack system 410 configured for a bicycle 5 and snow sports equipment (e.g., snowboard 406 and skis 407) as it may be mounted in a pickup truck bed 3. The base 412 of the modular rack system 410 includes a lower frame portion 414 having at least two vertically extending lower support members 432a, 432b and at least one horizontally extending lower support member 434a located between the at least two vertically extending lower support members 432a, 432b. To support the front and rear tires of a bicycle 5, the base 412 further includes at least two additional vertically extending lower support members 426a, 426b and an additional horizontal lower support member set 434b apart from and substantially parallel to the horizontal lower support member 434a, thereby supporting and stabilizing the bicycle tires 6, 7 therebetween.

An upper frame portion 450 connects to the lower frame portion 414 of the base 412. The upper frame portion 450 has at least two vertically extending upper support members 452a, 452b and at least one horizontally extending upper support member 454 positioned between the vertically extending upper support members 452a, 452b. A plurality of openings 460 are formed through and along both the vertically extending upper support members 452a, 452b and optionally through the vertically extending lower support members 432a, 432b. A plurality of brackets 480 are detachably mounted to the upper frame portion 450 via the plurality of openings 460. The plurality of brackets extend outwardly from the upper frame portion 450 to receive and support snow sports equipment (and/or other equipment) elevated above the base 412.

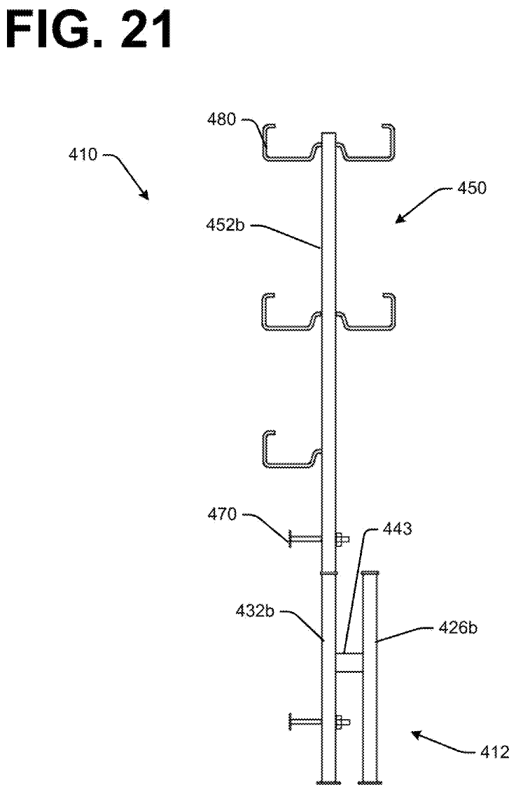

Additionally, at least one anti-sway pin 470 is adjustably mounted to a second set of the plurality of openings 460 on the upper frame portion 450 and/or the lower frame portion 414. In an example, the anti-sway pin 470 is a threaded bolt with one or more nuts that can be attached and set at the desired spacing, as shown for example in FIG. 21. Four pins 470 are shown in the drawings, but could be any number to provide the desired lateral stability. The at least one pin 470 extends horizontally toward and is configured to contact or brace against an inner side wall 2 of the truck bed 3 to provide lateral stability and reduce or altogether eliminate overhead sway during transport. In other configurations, multiple pins 470 may be selectively positioned on the rack system 410 to accommodate different truck bed dimensions and/or the distance the base 412 is positioned from the truck bed 3 side wall. The pins 470 may feature rubberized or padded contact tips to protect the painted surfaces of the vehicle 1.

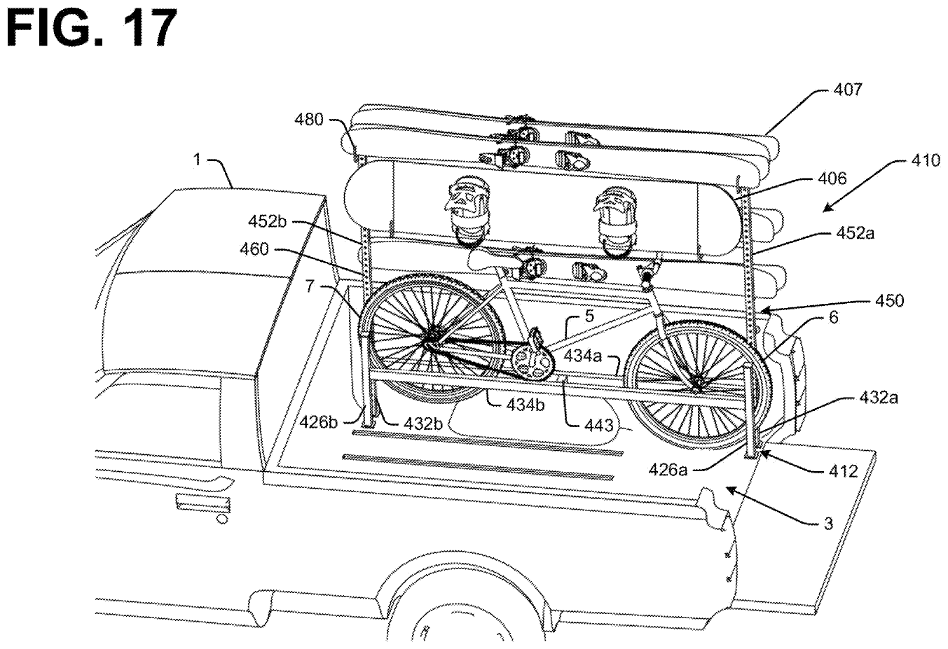

FIG. 17 is a perspective view of the modular rack system 410 shown as it may be loaded with outdoor recreational equipment inside the truck bed 3. This configuration illustrates the multi-tiered utility of the system, including an upright bicycle 5 secured in the base 412 along the lower horizontal frame portion 414, a snowboard 406 on the brackets 480, and multiple pairs of skis 407 on the upper brackets 480.

In other examples, the base 412 can incorporate the adjustable wedge tire stops (e.g., 340a-b, 342a-b), sliding wheel trays (e.g., 18, 20), or slotted cross members described in previous examples to accommodate varying bicycle sizes, including race bicycles, e-bicycles, and fat-tire bicycles with tire widths (e.g., which can range from 1 inch to 4 inches). Furthermore, while shown holding snow sports equipment, the outwardly extending brackets 480 may be varyingly spaced or reconfigured to transport other elongated outdoor gear, such as surfboards, paddleboards, and/or trade tools.

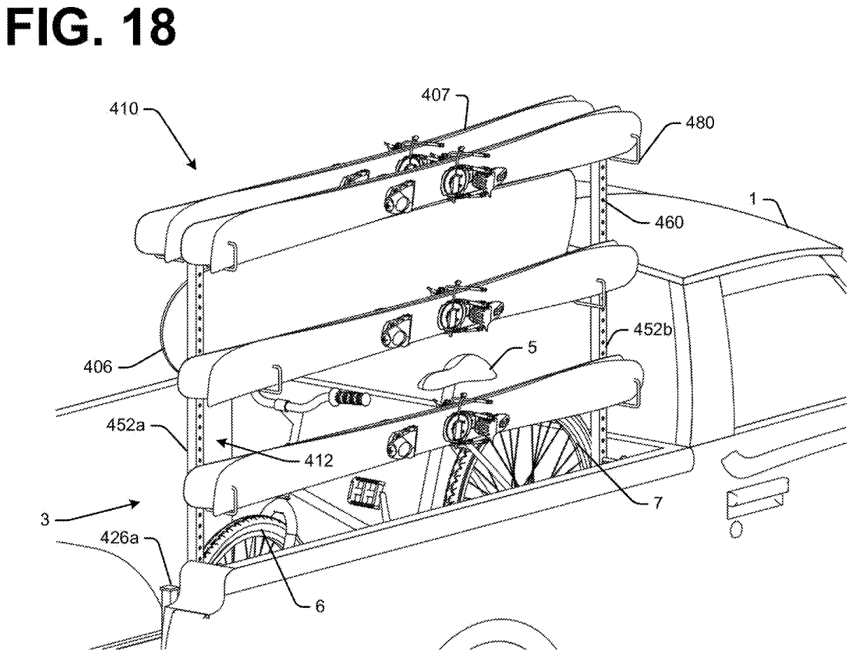

FIG. 18 shows a reverse profile view of the loaded modular rack system 410 of FIG. 17, showing how the bicycle 5, snowboard 406, and skis 407 may appear when standing outside of the truck 1 directly next to the truck bed side rail or wall 2. This view shows the spatial clearance maintained within the truck bed 3 and demonstrates how the horizontally extending anti-sway pin 470 bridges the distance between the vertical column of the rack system 410 and the side wall 2 of the truck bed 3. By transferring lateral forces against the structural walls of the truck bed 3, the pin 470 dampens travel energy and prevents the heavy, elevated recreational equipment from tipping or shifting. Other configurations may include an interlocking mechanism interacting with the pin 470 and/or the openings 460 to secure the rack system 410 to the side wall 2 of the truck bed 3.

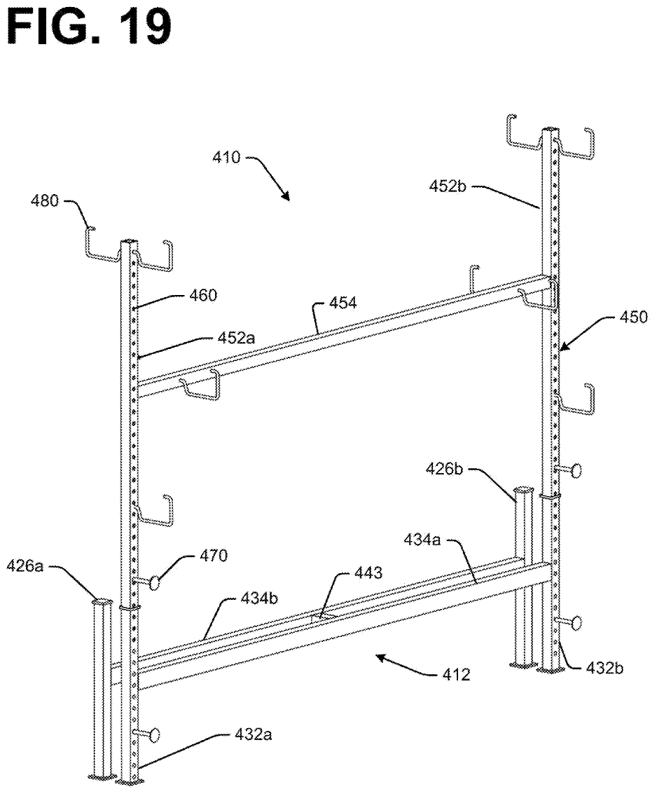

FIG. 19 is a perspective view of the modular rack system 410 shown separate from the vehicle 1. As an independent assembly, the upper frame portion 450 is detachably coupled to the lower frame portion 414 of the base 412 such that the entire upper frame portion 450 can be cleanly separated and removed from the base 412 when transporting snow sports equipment (or other equipment) on the upper frame portion 450 is not required. This modularity allows a user to leave only the low-profile base 412 in the truck bed 3 for day-to-day bicycle transport, restoring rearward visibility and truck bed cargo space.

In an example configuration, the detachable upper frame portion 450 connects to the lower frame portion 414 via a telescopic coupling or a ferrule connection. Other attachments may also be provided. To reinforce the lower structural base 412, at least one cross brace 443 is positioned between the horizontally extending lower support members 434a and 434b. In other examples, the upper frame portion 450 may be formed to include an integrated artistic design element, such as a silhouette of mountains, wildlife, or trees, welded between the support members to add aesthetic value without interfering with the function of the brackets 480.

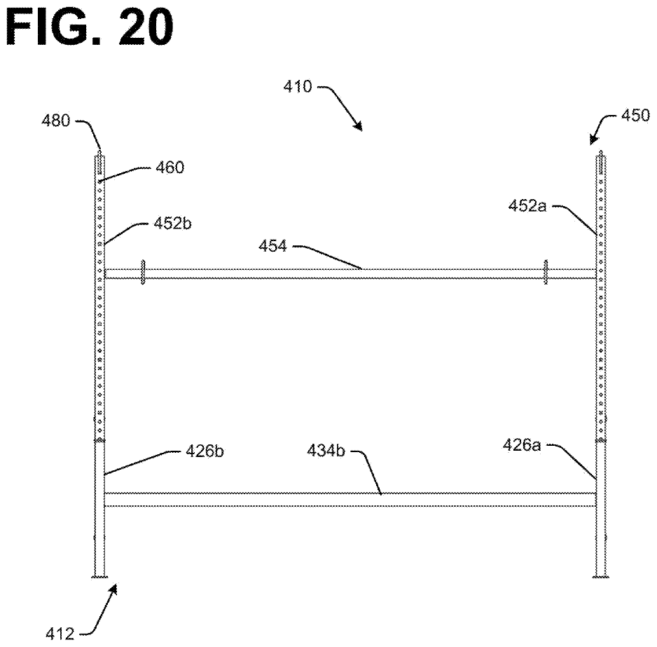

FIG. 20 is a side elevation view of the modular rack system 410 corresponding to FIG. 19. This view shows the wide-profile geometric relationship of the standalone assembly, illustrating the vertical alignment of the upper support members 452a, 452b with the lower support members 432a, 432b. The even distribution of the plurality of openings 460 along the columns allows for fine-grained height adjustment of the upper frame portion 450 relative to the base 412, providing compatibility with varying truck bed depths. In other configurations, the horizontally extending lower support member 434a and upper horizontal support member 454 may include telescoping or width-adjustable tubing, enabling the modular rack system 410 to expand or contract to securely fit mid-size, full-size, or wide-body pickup truck beds.

FIG. 21 is a front elevation view of the modular rack system 410 corresponding to FIG. 19, showing the narrow end profile of a single vertical support column assembly. This view illustrates the compact, tiered layout of the rack system 410. The plurality of brackets 480 are shown in this example as being substantially U-shaped or hook-shaped, and extending symmetrically outward from both sides of the upper support column to maximize carrying capacity. Other brackets and bracket configurations are also contemplated as being suitable for use with the modular rack system 410.

The nesting mechanism of the telescopic coupling between the upper and lower frame components is also visible, alongside the horizontal orientation of the adjustably mounted anti-sway pins 470. In other configurations, the brackets 480 may be pivotally mounted to the columns via the openings 460, allowing them to fold flat against the frame when not in use or rotate to alternative angles to hold specialized cargo shapes.

It is understood that the aspects of the modular rack system detailed in FIGS. 15-21 can be readily integrated with the features of the previously described bicycle rack examples. For example, the base or lower frame portion of the new modular system could incorporate the adjustable wedge tire stops, sliding wheel trays, or slotted cross members described previously to further secure the bicycle wheels. Additionally, the detachable upper frame portion could be formed to include an artistic design element, such as a silhouette, without interfering with the outwardly extending brackets. It should be noted that aspects described in the earlier examples could be combined with aspects in the modular rack system, as would be well within the purview of someone having ordinary skill in the art after becoming familiar with the teachings herein.

It is noted that the examples shown and described are provided for purposes of illustration and are not intended to be limiting. Still other examples are also contemplated.

1. A modular rack system for securely transporting a combination of one or more bicycles and snow sports equipment in a truck bed, comprising:
a base configured to be positioned on a floor of a truck bed for receiving wheels of a bicycle to secure the bicycle in an upright position;
a lower frame portion of the base having at least two vertically extending lower support members and at least one horizontally extending lower support member between the at least two vertically extending lower support members;
an upper frame portion connecting to the lower frame portion of the base, the upper frame portion having at least two vertically extending upper support members and at least one horizontally extending upper support member between the at least two vertically extending upper support members, the upper frame portion configured to receive and support snow sports equipment elevated above the base; and
at least one pin extending horizontally from the lower frame portion and/or the upper frame portion, the at least one pin configured to extend toward a wall of the truck bed for reducing sway.

2. The modular rack system of claim 1, wherein the upper frame portion is detachably coupled to the lower frame portion by a telescopic coupling such that the upper frame portion can be separated and removed from the lower frame portion.

3. The modular rack system of claim 1, wherein the at least one pin is adjustably mounted to accommodate placement of the modular rack system at different distances from a side wall of the truck bed.

4. The modular rack system of claim 1, wherein the base is configured to rest on the floor of the truck bed and is held in place by at least one strap.

5. The modular rack system of claim 1, wherein the base is configured to securely anchor to the floor of the truck bed.

6. The modular rack system of claim 1, further comprising a plurality of brackets mounted to the at least two vertically extending upper support members of the upper frame portion, the plurality of brackets extending outwardly from the vertically extending support members.

7. The modular rack system of claim 6, wherein the plurality of brackets are substantially U-shaped or hook-shaped to hold the snow sports equipment.

8. The modular rack system of claim 1, wherein the base has at least two additional vertically extending lower support members set apart from and substantially parallel to the at least one horizontally extending lower support member of the lower frame portion, and wherein the base has at least one additional horizontally extending lower support member between the at least two additional vertically extending lower support members set apart from and substantially parallel to the at least one horizontally extending lower support member of the lower frame portion, and wherein the front and rear tires of the bicycle are supported therebetween.

9. The modular rack system of claim 8, further comprising at least one cross brace between the at least one horizontally extending lower support member of the lower frame portion and the at least one additional horizontally extending lower support member.

10. The modular rack system of claim 1, wherein the upper frame portion has a plurality of openings formed therethrough for mounting a plurality of brackets thereto.

11. The modular rack system of claim 1, wherein the upper frame portion has a plurality of openings formed therethrough for mounting the at least one pin.

12. The modular rack system of claim 1, wherein the lower frame portion has a plurality of openings formed therethrough for mounting the at least one pin.

13. A modular rack system for a truck bed, comprising:
a base configured to be positioned on a floor of a truck bed;
a lower frame portion of the base, the lower frame portion including at least two vertically extending lower support members;
an upper frame portion extending upwardly from the lower frame portion, the upper frame portion including at least two vertically extending upper support members, wherein a plurality of openings are formed along the vertically extending upper and lower support members;
a plurality of brackets detachably mounted to the upper frame portion via a first set of the plurality of openings, the plurality of brackets extending outwardly from the upper frame portion and configured to support snow sports equipment; and
at least one pin adjustably mounted to a second set of the plurality of openings on either the upper frame portion or the lower frame portion, the at least one pin extending horizontally and configured to contact a side wall of the truck bed to provide lateral stability.

14. The modular rack system of claim 13, wherein the upper frame portion is detachably coupled to the lower frame portion such that the upper frame portion can be separated and removed from the lower frame portion.

15. The modular rack system of claim 14, wherein the detachably coupled upper frame portion and lower frame portion connect via a ferrule connection.

16. The modular rack system of claim 13, wherein the base is configured to receive front and rear wheels of a bicycle to secure the bicycle in an upright position.

17. The modular rack system of claim 13, wherein the at least one pin is selectively movable between different openings of the plurality of openings to accommodate placement of the modular rack system at different distances from the side wall of the truck bed.

18. The modular rack system of claim 13, further comprising at least one horizontally extending support member positioned between the at least two vertically extending lower support members or between the at least two vertically extending upper support members.

19. The modular rack system of claim 13, wherein the base is configured to securely anchor to the floor of the truck bed or is held in place by at least one strap.

20. A modular rack system for securely transporting a combination of one or more bicycles and snow sports equipment in a truck bed, comprising:
a base configured to be positioned on a floor of a truck bed;
a lower frame portion of the base, the lower frame portion having at least two vertically extending lower support members, the base having at least two additional vertically extending lower support members set apart from and substantially parallel to the at least two vertically extending lower support members, and at least one horizontal support member;
an upper frame portion extending upwardly from the lower frame portion, the upper frame portion having at least two vertically extending upper support members, wherein the upper frame portion is detachably coupled to the lower frame portion such that the upper frame portion can be separated and removed from the lower frame portion;
wherein the vertically extending upper support members and the vertically extending lower support members each include a plurality of openings formed therethrough;
a plurality of substantially U-shaped brackets detachably mounted to the upper frame portion via a first set of the plurality of openings; and
at least one pin adjustably mounted to a second set of the plurality of openings on either the vertically extending upper support members or the vertically extending lower support members, the at least one pin extending horizontally from the upper or lower frame portion and configured to extend toward a wall of the truck bed to reduce sway.
